(19) United States
(12) Patent Application Publication
(10) Pub. No.: US 2007/0068257 A1
(43) Pub. Date: Mar. 29, 2007

(54) Method of measuring the thickness of layers by surface waves

(75) Inventors: Farid Belahcene, Troyes (FR); Jean-yves Chatellier, Arcueil (FR); Pierre Cortesi, Saint Germain Les Corbeil (FR); Christian Ducrocq, Varennes Jarcy (FR)

Correspondence Address: OBLON, SPIVAK, MCCLELLAND, MAIER & NEUSTADT, P.C., 1940 DUKE STREET, ALEXANDRIA, VA, 22314, US

(73) Assignees: SNECMA, Paris (FR); ULTRA RS, Rosieres-Pres-Troyes (FR)

(21) Appl. No.: 11/526,633

(22) Filed: Sep. 26, 2006

(30) Foreign Application Priority Data
Sep. 26, 2005 (FR) 0552882

(51) Int. Cl. G01H 13/00; G01H 5/00

(52) U.S. Cl. 73/597; 73/579

(57) ABSTRACT

The invention relates to a method of determining the thickness of a surface layer of a part having a structure different from that of the material constituting the part beneath said layer. It consists in generating a beam of Rayleigh waves on the surface of the part at a first frequency, in measuring the wave propagation velocity, in repeating the operation several times with Rayleigh waves at different frequencies, in recording the wave propagation velocities and the corresponding wavelengths and in classifying them by increasing wavelengths. The thickness of said layer is defined by the wavelength above which a plateau in the variation of said velocity is observed.

The present invention relates to the non-destructive inspection of a part and in particular to the checking of the thickness or depth of treatment of a metal part.

In an aeronautical gas turbine engine, one highly stressed part is the bearing race of the low-pressure turbine bearing. To obtain a hard surface layer, the part is treated by nitriding it in a furnace in a nitrogen atmosphere. This is a thermochemical treatment involving the diffusion of nitrogen alone, carried out between 300 and 900° C. The nitrided zone extends over a depth of less than one millimetre.

According to a known checking mode, in a nitriding campaign carried out on a batch comprising a number of parts, rolling race sectors are added to the batch in the furnace.

After treatment, these test pieces are sectioned and subjected to Vickers hardness tests on slices 0.1 mm in depth. Curves called hardness relationship curves are plotted from the measured values and the depth associated with a given hardness is read therefrom. A microphotographic examination of the test pieces is also carried out. The treated thickness corresponds to the thickness of the metal whose hardness is greater than the given hardness.

This method has drawbacks:
it requires time to do the sectioning and carry out the tests;
it destroys one part per treatment campaign;
the thickness is known only at a single point on the race, the method not making it possible to know if there is eccentricity or if the operating conditions are not homogeneous in the furnace; and
the thickness is measured only on a control test piece and not on each of the parts treated.

There is therefore a need, and it is this that forms the objective of the invention, for a method of measuring the thickness of the treated layer that is both non-destructive and rapid.

It would also be desirable for this method to provide a precise measurement, for example to within ±0.05 mm, of the treated layer.

Finally, this method should allow measurement at different points on the part, in particular in the case of a bearing race at different points on its circumference.

Non-destructive inspection techniques involving sound and ultrasound waves are known. For example, U.S. Pat. No. 5,987,991 discloses a method of evaluating or validating a treated zone in which the presence of defects is sought, such as the leading edge of a turbojet fan blade hardened by laser impact, comprising the determination of the critical angles of Rayleigh waves produced on the surface of the part by a generator producing beams of ultrasound waves.

The invention makes it possible to satisfy the abovementioned need by employing a novel application of Rayleigh waves or surface waves.

According to the invention, the method of determining the thickness of a surface layer of a part, especially a metal part, said layer having a structure different from that of the material constituting the part beneath said layer, is characterized in that it consists in generating a beam of Rayleigh waves on the surface of the part at a first frequency, in measuring the wave propagation velocity, in repeating the operation by generating Rayleigh waves at different frequencies, in recording the wave propagation velocities and the corresponding wavelengths and in classifying them by increasing wavelengths, the thickness of said layer being defined by the wavelength above which a plateau in the variation of said velocity is observed.

Advantageously, the waves generated lie within the 1 to 15 MHz range and more particularly the 3 to 12 MHz range. In the latter case, the depths explored range from 0.25 to 1 mm.

The invention results from the observation whereby Rayleigh waves propagating over small thicknesses near the surface of the material are sensitive to any structural modification of this surface layer.

It follows that any structural modification affects the propagation velocity of a Rayleigh wave.

Moreover, it is known that by modifying the frequency of the wave its penetration depth is modified, but that this variation in frequency does not affect the propagation velocity of a Rayleigh wave.

It therefore suffices, by modifying the frequency, to record the depth at which the velocity stabilizes. This depth corresponds to the thickness of the surface layer having a structure different from that of the rest of the material.

To the knowledge of the Applicant, hitherto Rayleigh waves have not been used for measuring the thickness of a thin surface layer of a material having a microstructure different from that of the rest of the material, this difference resulting from a treatment applied to the surface, such as nitriding or case hardening, but also shot peening, roller burnishing, or the like.

Preferably, the method is applied to the determination of nitrided layers with a thickness of at least 0.3 mm.

The method has certain advantages over the prior art:
it is rapid, taking about 5 minutes as opposed to 15 hours for a destructive inspection;
it is economical since no part, which may intrinsically be expensive, is destroyed;
it is precise, the difference between the thickness measurement by this method and that carried out from thicknesses obtained by dissection being ±0.05 mm;
it allows the number of inspection points on the same part, or on different parts of the same batch, to be increased; and
the part itself, and not a control, is inspected.

U.S. Pat. No. 4,730,494 discloses a technique that operates at very high frequency, namely 300/500 MHz. This technique is aimed only at very thin layers, of around 5 μm. Also known, from U.S. Pat. No. 5,648,611, is the use of Rayleigh waves and the prior construction of propagation velocity/thickness charts for several frequencies. The inspection is in fact carried out at a single frequency with the corresponding propagation velocity being measured. The invention, apart from the simplicity of implementation, allows better precision, namely 0.05 mm, as opposed to 0.5 mm.

The invention will be now be described in greater detail with reference to the appended drawings in which:

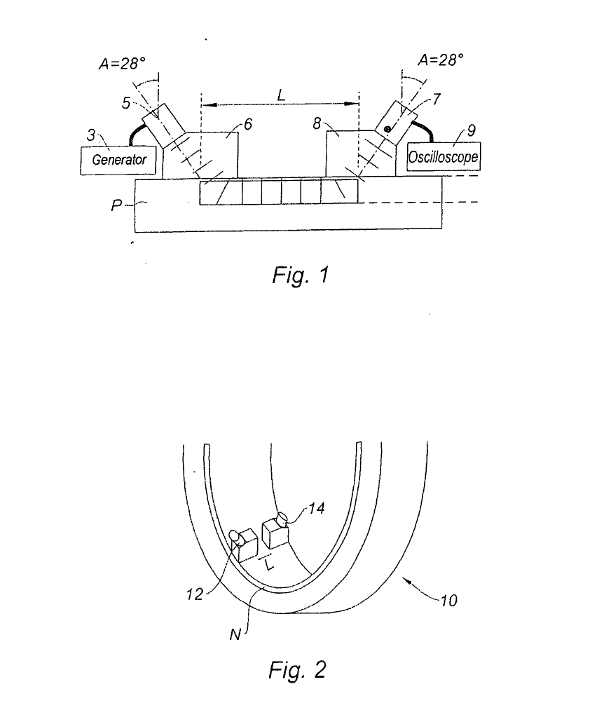

FIG. 1 shows the diagram of an inspection device for implementing the invention;

FIG. 2 shows the application of a device of FIG. 1 to the inspection of a bearing race;

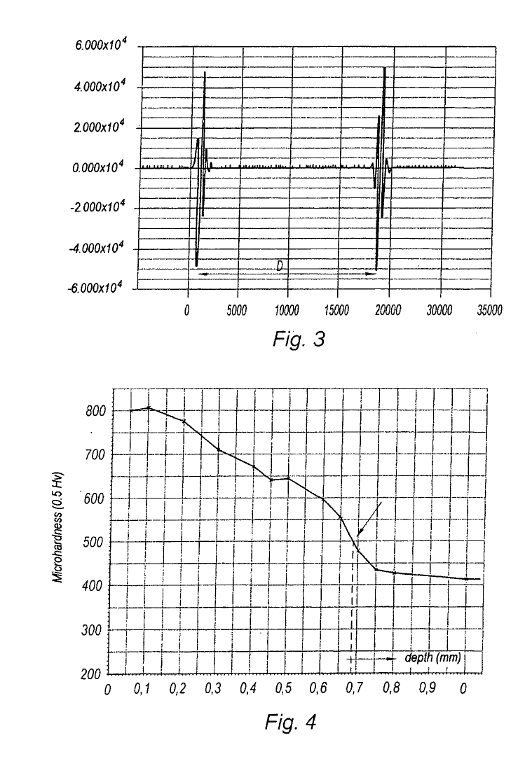

FIG. 3 shows the trace of a signal on an oscilloscope corresponding to the travel of the Rayleigh wave;

FIG. 4 shows an example of a relationship curve; and

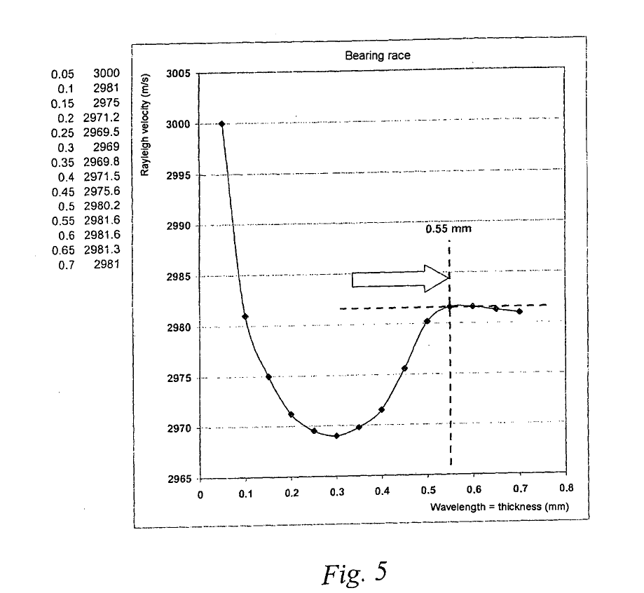

FIG. 5 shows a curve of the propagation velocity of the surface waves as a function of the depth of penetration of the surface waves for an example of a nitrided bearing race.

FIG. 1 shows a pulse generator 3 that delivers an electrical signal of a few MHz, the frequency of which being in relation with the ultrasonic transducer used. The electrical signal is converted into ultrasound waves of the same frequency by the transducer 5 through the piezoelectric effect. The transducer is mounted on a comer mounting 6, made of suitable material such as PMMA. The mounting is placed on the surface of the part P and fixed thereto by known means. The angle A that the transducer makes, therefore the direction of the waves emitted, with the surface of the part is determined according to the material of the part, and is also known per se. For example in the case of titanium, the angle is 30°, while for steel it is 28°. This is a critical wave propagation angle and is such that a mode conversion takes place at the corner/material interface and a Rayleigh wave then propagates parallel to and in the vicinity of the surface of the part.

The Rayleigh wave, which radiates energy in the direction of angle + or − A, reaches the second mounting 8 placed symmetrically with respect to the first mounting and is received by the transducer 7, similar to the first transducer. The ultrasound wave is converted back to an electrical signal through the piezoelectric effect by this receiver transducer. The distance L between the two sensors is predetermined and fixed. The electrical signal received is sent to an oscilloscope 9. FIG. 3 shows the trace produced on the screen of the oscilloscope. The distance D between the wave trains displayed on the oscilloscope thus allows the wave propagation time to be measured. Since the distance L is also known, the wave propagation velocity is determined.

Any modification in the velocity can be imputed only to a modification in the state of the material. This is due to the non-dispersive nature of Rayleigh waves.

Moreover, it is known that the thickness over which the sensitivity of this wave is exerted is of the order of the wavelength λ, since the field of the stresses induced by the wave becomes negligible beyond a depth equal to λ. By modifying the frequency of the Rayleigh waves, the depth of penetration into the material is therefore modified.

The equation λ=V_{Rayleigh}/f, where f is the frequency of the Rayleigh wave and V_{Rayleigh} is the velocity of the Rayleigh wave in m/s, is true when the structure of the material through which the wave passes remains the same when the depth of penetration of the wave is varied.

Thus, according to the invention, by measuring the wave propagation velocity for different frequencies; that is to say for different penetration depths, until the velocity no longer varies, the depth at which the untreated material of the part lies is determined.

Tests

To verify the method, tests were carried out on low-pressure rotor bearing races of a gas turbine engine that were subjected to a nitriding treatment, and after removal of the white layer. The nitriding thickness is normally determined from Vickers hardness measurements. A control test piece sector placed near the part undergoing thermochemical treatment is used to estimate the hardness. A hardness test is carried out point by point every 0.05 mm in depth starting from the periphery of the race. At each position, the Vickers hardness (0.5 Hv microhardness) is recorded. A curve called the relationship curve is plotted, in which the hardness is charted for each depth (in mm). FIG. 4 reproduces such a curve. The procedure adopted considers that the nitriding thickness is that for which the Vickers hardness reaches a value of 500. Thus, in the example indicated, the nitriding thickness is 0.67 mm.

Tests on a race with a nitriding thickness of 0.53 mm were carried out.

FIG. 2 shows a race 10 with a nitrided layer N on the internal face of the bearing zone, the thickness of which layer it is desired to determine. The figure shows the positioning of the two transducers, one the emitter 12 and the other the receiver 14 a defined distance L apart. The direction of the two transducers is preferably axial so as to avoid having to take into consideration the curvature of the part. The two transducers are connected, the first to a pulse generator of the MATEC type, which has the particular feature of generating a single-frequency wave, and the second to an oscilloscope.

Measurements were carried out on this race at several points along the axis and around the circumference. The measurements consisted in recording the propagation velocity of Rayleigh waves at various successive frequencies chosen so that the wavelength is incremented by 0.05 mm.

| Frequency (MHz) | Wavelength = penetration (mm) |
|---|---|
| 12.0 | 0.25 |
| 10.0 | 0.30 |
| 8.6 | 0.35 |
| 7.5 | 0.40 |
| 6.7 | 0.45 |
| 6.0 | 0.50 |
| 5.45 | 0.55 |
| 5.0 | 0.60 |
| 4.6 | 0.65 |
| 4.3 | 0.70 |
| 4 | 0.75 |
| 3.75 | 0.80 |
| 3.53 | 0.85 |

Next, in an orthonormal coordinate system, the penetration depth of the Rayleigh wave was plotted on the x-axis and the propagation velocity, as measured with the device, was plotted on the y-axis. The polynomial curve passing through the recorded points was plotted.

The graph of FIG. 5 shows that the velocity decreases rapidly at very small thicknesses, in the zone of the part having high residual stress gradients. The propagation velocity after having reached a minimum increases up to a pseudo-plateau once the investigated thickness exceeds the nitriding depth. In FIG. 5, the nitrided thickness is estimated to be 0.55 mm.

By plotting the curve for the measurement carried out at various points, distributed axially relative to one another over the circumference of the internal face of the race, it was found that the curve remained substantially the same. This observation made it possible to deduce therefrom that the nitriding distribution remained uniform.

The method allows the treatment of batches of parts to be validated rapidly, reliably and fully. Preferably, a specified number of parts of the batch is inspected, and at most all parts.

For each part, several points distributed over the part are inspected. For example, in the case of a race, four diametrically opposed points in pairs are inspected.

After nitriding, the surface is covered with what is called a “white” layer, which is removed by grinding the surface. This layer has a thickness of around 100 μm. The inspection is preferably carried out after this “white” layer has been removed.

However, it will be understood that the invention is not limited to the inspection of nitrided parts. It applies to any treatment involving a surface modification of the structure of the material over a thickness that may be of the order of one millimetre.

The proposed method differs from other methods, and makes it possible from a single curve on the test piece to estimate the nitriding thickness without having preestablished charts for a large number of parts nitrided to different depths. Because the frequency is varied with the desired pitch, the precision of the method, referring to the table, is 0.05 mm. A complete experimental program has demonstrated greater robustness and accuracy of the ultrasonic method described as compared with the destructive “hardness relationship” method.

1. Method of determining the thickness of a surface layer of a part having a structure different from that of the material constituting the part beneath said layer, consisting in generating a beam of Rayleigh waves on the surface of the part at a first frequency, in measuring the wave propagation velocity, in repeating the operation several times with Rayleigh waves at different frequencies, in recording the wave propagation velocities and the corresponding wavelengths and in classifying them by increasing wavelengths, the thickness of said layer being defined by the wavelength above which a plateau in the variation of said velocity is observed, the frequencies of the generated waves being between 1 and 15 MHz.

2. Method according to claim 1, in which the propagation velocity of the waves is measured between a first transducer on the surface of the part for emitting the surface waves and a second transducer a specified distance away for receiving the surface waves.

3. Method according to claim 1, the layer of which is a layer obtained by treatment of a metal part.

4. Method according to claim 3, the surface treatment of which is a mechanical surface treatment, such as shot peening or roller burnishing.

5. Method according to claim 3, the surface treatment of which is a thermochemical treatment, such as nitriding or case hardening.

6. Method according to claim 3, applied to the validation of a batch of treated parts.
